(19) United States
(12) Patent Application Publication
(10) Pub. No.: US 2026/0270945 A1
(43) Pub. Date: Sep. 10, 2026

(54) ENHANCEMENTS IN NAMF COMMUNICATION SERVICE OF AMF FOR UE POSITIONING

(71) Applicants: Centre of Excellence in Wireless Technology, Chennai (IN); Indian Institute of Technology Madras (IIT Madras), Chennai (IN)

(72) Inventors: Aswathy Subramaniam, Chennai (IN); Harini Shree Velmurugan, Chennai (IN); Abhijeet Abhimanyu Masal, Chennai (IN); Anusuya Balasubramanian, Chennai (IN); Jeniston Deviraj Klutto Milleth, Chennai (IN); Bhaskar Ramamurthi, Chennai (IN)

(21) Appl. No.: 19/533,051

(22) Filed: Feb. 6, 2026

(30) Foreign Application Priority Data
Feb. 7, 2025 (IN) 202541010351

(51) Int. Cl. H04W 64/00

(52) U.S. Cl. CPC H04W 64/00

(57) ABSTRACT

UE positioning is the process of determining the accurate location of a mobile device within a cellular network. The Location Management Function (LMF) in the 5G Core plays a key role in the positioning process. It works with various network elements, receiving assistance and measurement data from the next-generation radio access network (NG-RAN) and the user equipment (UE) through the Access and Mobility Management Function (AMF) to accurately compute the UE's position. Positioning is supported by protocols such as LTE Positioning Protocol (LPP) and NR Positioning Protocol Annex (NRPPa) for communication between the UE and NG-RAN respectively. The LMF uses the Namf-Communication service of the AMF to communicate with both the UE and NG-RAN. The LMF can request non-UE-specific NRPPa messages to be sent to multiple NG-RAN nodes. This invention focuses on a mechanism to report partial or complete failures in NRPPa message transfer to NG-RAN nodes by the AMF. It also proposes the addition of NG-RAN identification in the NRPPa response message to the LMF, using which the LMF can provide NRPPa Error Indication to the NG-RAN node, assisting the AMF in routing it to the appropriate NG-RAN node.

### FIELD OF INVENTION

The present invention generally relates to wireless communications. More specifically, the present invention is related to method for handling communication in a network for a user equipment (UE) positioning and for providing source information in a network for the UE positioning.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Wireless communication systems are widely deployed to provide various telecommunication services such as telephony, video, data, messaging, and broadcasts. These systems have developed through various generations to provide a common protocol that enables different wireless devices to communicate on a municipal, national, regional, and even global level.

The 3rd Generation Partnership Project (3GPP) is a global forum consisting of several standards organizations which develop protocols for mobile telecommunication. A standard telecommunication system following 3GPP standards consists of multiple components namely the user equipment (UE), base station (BS) and the Core Network. An example telecommunication standard is 5G New Radio (NR). A fifth generation (5G) wireless standard, referred to as New Radio (NR), enables higher data transfer speeds, greater numbers of connections, and better coverage, among other improvements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology.

Positioning of UE is a key feature in 5G due to its broad applicability across diverse business sectors. One prominent use case is emergency call positioning, which is gaining importance due to regulatory requirements from the Federal Communications Commission (FCC). Numerous other critical services also rely on high-precision UE positioning, with increasingly demanding requirements for accuracy, time-to-first fix, and latency. Additionally, new commercial applications and use cases in 5G and beyond are emerging, each imposing even stricter positioning standards.

UE positioning is the process of determining the accurate location of a mobile device within a cellular network. The Location Management Function (LMF) in the 5G Core plays a key role in the positioning process. It works with various network elements, receiving assistance and measurement data from the radio access network (RAN) and the user equipment (UE) through the Access and Mobility Management Function (AMF) to accurately compute the UE's position. Positioning is supported by protocols like LTE Positioning Protocol (LPP) and NR Positioning Protocol Annex (NRPPa) for communication between the UE and RAN respectively. The LMF uses the Namf_Communication service of AMF to communicate with both the UE and RAN. LMF can request some non-UE associated NRPPa messages, to be sent to multiple RAN nodes. During the execution of this procedure, two fallback scenarios in the existing services have been identified. The identified issues include the inability to convey partial or complete failure to the LMF in the delivery of the NRPPa message from the AMF to the RAN node. Additionally, the source RAN node information is not provided to the LMF by AMF, when the NRPPa response is received from RAN.

This invention focuses on a mechanism to report partial or complete failures indication to LMF in NRPPa message transfer to RAN node by AMF. It also proposes the addition of RAN identification in the NRPPA response message to the LMF. Using which LMF can provide the NRPPa Error Indication to the appropriate RAN node when the decoding of the NRRPa message failed at LMF, thus assisting the AMF to route it to the appropriate RAN node.

The embodiments of the present disclosure address these issues arising from partial or complete failures in transferring non-UE associated NRPPa messages and ensure that the source RAN node information is provided in the NRPPa response to the LMF. Together, these solutions assist the LMF in deciding on further proceedings in the positioning process. This approach ensures reliable error reporting and improved handling of NRPPa message transfers, facilitating efficient UE positioning process management.

### SUMMARY OF THE INVENTION

In general, embodiments of the present disclosure herein provide method for communication in a network for a user equipment (UE) positioning and for providing source information in a network for the UE positioning in a wireless communication system. Other implementations will be or will become, apparent to one with skill in the art upon examination of the following figures and detailed description. It is intended that all such additional implementations be included within this description be within the scope of the disclosure and be protected within the scope of the following claims.

In one embodiment, the present disclosure provides a method for communication in a network for a user equipment (UE) positioning in a wireless communication system. The method comprises, receiving, by a first node, a request from a second node to transfer a message to plurality of Next-Generation Radio Access Network (NG RAN) targets. The method further comprises, delivering, by the first node, the message to each of the NG RAN in the plurality of NG RAN targets. The method further comprises, determining, by the first node, the message is successfully delivered to each of the NG RAN in the plurality of NG RAN targets. The method further comprises, sending, by the first node, a response to the second node containing the delivery status; wherein the delivery status comprises one of: partial delivery along with at least one of structured list containing NG RAN target failed to deliver the message and reason for the corresponding failure when the message is delivered to only some of the NG RAN in the plurality of NG RAN targets, and failed delivery along with at least one of structured list containing NG RAN target failed to deliver the message and reason for the corresponding failure when the message is delivered to none of the NG RAN in the plurality of NG RAN targets.

In another embodiment, the present disclosure provides a method for providing source information in a network for user equipment (UE) positioning in a wireless communication system. The method comprises, receiving, by the first node, an assistance data from a Next-Generation Radio Access Network (NG RAN). The method further comprises, identifying, by the first node, a unique node identifier associated with the NG RAN. The method further comprises, sending, by the first node, a notification to the second node, wherein the notification comprises of the assistance data and the unique node identifier.

The above summary is provided merely for the purpose of summarizing some exemplary embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject will become apparent from the description, the drawings, and the claims.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 illustrates a schematic representation of a positioning network architecture in accordance with embodiments of the present disclosure;

FIG. 2 illustrates a method of NonUeN2Message Transfer in accordance with embodiments of the present disclosure;

FIG. 3 illustrates a method of NonUeN2Message Transfer in accordance with embodiments of the present disclosure;

FIG. 4 illustrates a method of Non-UE information notify in accordance with embodiments of the present disclosure;

FIG. 5 illustrates the components that may be employed in a Network Function(s), and configured to support wireless communications in accordance with an embodiment of the present disclosure;

FIG. 6 illustrates a method of handling communication in a network for a user equipment (UE) positioning in wireless communication system in accordance with an embodiment of the present disclosure;

FIG. 7 illustrates a method of providing source information in a network for a user equipment (UE) positioning in wireless communication system in accordance with an embodiment of the present disclosure;

FIG. 8 illustrates block diagram an example communication system configured to implement positioning methods described in the present disclosure

A more complete understanding of the present invention and its embodiments thereof may be acquired by referring to the following description and the accompanying drawings.

### DETAILED DESCRIPTION OF THE INVENTION

The detailed description set forth below in connection with the appended drawings is intended as a description of various embodiments of the present invention and is not intended to represent the only embodiments in which the present invention may be practiced. Each embodiment described in this invention is provided merely as an example or illustration of the present invention, and should not necessarily be construed as preferred or advantageous over other embodiments. The detailed description includes specific details for the purpose of providing a thorough understanding of the present invention. However, it will be apparent to those skilled in the art that the present invention may be practiced without these specific details.

Some embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

Embodiments herein are described within the context of 5G NR radio technology. It is to be appreciated that the problems and solutions mentioned herein apply equally to wireless access networks and UEs that use different access technologies and standards. NR is used as an example technology where embodiments are appropriate, and include NR in the description is therefore very valuable for understanding the problem and finding solutions to it. In particular, embodiments are equally applicable to 3GPP LTE, or 3GPP LTE plus NR integration.

The wireless communication network comprises one or more Radio Access Networks (RANs) and one or more Core Networks (CNs). The wireless communication network may implement one or more of different technologies, such as LTE, LTE-Advanced, or Fifth Generation (5G). The following embodiments pertain to current technological advances that are especially relevant in the context of 5G, but they may also be used to further the advancement of future wireless communication systems like 5G Advanced and 6G.

In an embodiment, the wireless communication network comprises one or more radio network nodes (RAN) providing coverage over geographical areas of a radio access technology (RAT), such as NR, LTE, WiMAX or the like. The radio network nodes or the base stations may be a transmission and reception point e.g. a radio network node such as a Wireless Local Area Network (WLAN) access point or an Access Point Station (AP STA), an access node, an access controller, a base station, e.g. a radio base station such as a NodeB, an evolved Node B (eNB, eNode B), a gNodeB (gNB), a base transceiver station, a radio remote unit, an Access Point Base Station, a base station router, a transmission arrangement of a radio base station, a stand-alone access point or any other network unit or node capable of communicating with a UE within the area served by the network nodes depending e.g. on the RAT and terminology used. The radio network nodes communicate with the UE in form of downlink (DL) transmissions to the one or more UEs and Uplink (UL) transmissions from the one or more UE.

As used herein, the terms “user equipment” and “base station” are not intended to be specific or otherwise limited to any particular radio access technology (RAT), unless otherwise noted. In general, a UE may be any wireless communication device (e.g., a mobile phone, router, tablet computer, laptop computer, tracking device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). Generally, UEs can communicate with a core network via a RAN, and through the core network the UEs can be connected with external networks such as the Internet and with other UEs for voice. Of course, other mechanisms of connecting to the core network and/or the Internet are also possible for the UEs, such as over wired access networks, wireless local area network (WLAN) networks (e.g., based on IEEE 802.11, etc.) and so on.

A base station may operate according to one of several RATs in communication with UEs depending on the network in which it is deployed, and may be alternatively referred to as an access point (AP), a network node, a NodeB, an evolved NodeB (eNB), a New Radio (NR) Node B (also referred to as a gNB or gNodeB), etc.

The detailed description includes specific details for the purpose of providing a thorough understanding of the present invention. However, it will be apparent to those skilled in the art that the present invention may be practiced without these specific details.

UE Positioning is one of the vital features in 5G/6G mobile communication technology due to its wide range of business applications. Emergency call positioning is emerging as an important use case due to regulatory requirements from the Federal Communications Commission (FCC). Many other critical services rely on positioning as well, with much more stringent requirements on accuracy, time to first fix, and latency. Further, various commercial applications and use cases are coming up with more stringent positioning requirements in 5G and beyond systems.

UE positioning request can be initiated by an external Application Function (AF), location service (LCS) server or any internal network function (NF). After performing authorization of an external LCS Client or AF and verifying UE privacy via UDM, a Gateway Mobile Location Centre (GMLC) forwards a location request to LMF via AMF. The Location Management Function (LMF), a NF in the 5G-CN, manages the overall co-ordination and scheduling of resources required for determining the location of a UE. The LMF receives measurements and assistance information from the Radio Access Network (RAN) and the UE, via the Access and Mobility Management Function (AMF) to compute the position of the UE.

NR positioning protocol A (NRPPa) was introduced to carry the positioning information between RAN and LMF. Similarly, LMF provides positioning related configurations to UE using the LTE positioning protocol (LPP) via AMF. These additions in the 5G architecture provide the framework for enabling proper communication within the 5G system to provide accurate UE positioning in 5G. The Namf_Communication Service of AMF helps to transfer the N1 (Interface between UE and Core) and N2 (Interface between RAN and Core) messages to UE and RAN appropriately from LMF.

N2 messages handled by LMF, can be either UE specific or non-UE specific messages. The operations involved in Namf_Communication Service are UEContextTransfer, RegistrationStatusUpdate, N1N2Message Transfer (UE Specific), NonUeN2MessageTransfer, N1MessageNotify (UE Specific), N2InfoNotify and so on.

Location request of UE can be Network Induced, where serving AMF initiates the positioning request, or Mobile Originated, where UE sends the positioning request, or Mobile Terminated, where LCS client or AF via Network Exposure Function (NEF) sends the positioning request. The location request triggering entity will contact the GMLC. The authorization of the AF is performed by the NEF, and authorization of the external LCS Client is performed by the GMLC. The GMLC may then request target UE's privacy information from the (Unified Data Management) UDM via the Nudm interface. After verifying target UE privacy, the GMLC forwards the location request to AMF. AMF checks the reachability of UE, then if required verifies the user consent with UE to expose its location. On successful verification of both, AMF discovers the appropriate LMF to handle this location request and forwards the request to the selected LMF using N1mf_determineLocation service.

Various positioning methods, such as uplink (UL)-Angle of Arrival (AoA) and downlink (DL)-Time Difference of Arrival (TDOA), are used to determine the UE's location. Based on the positioning request and system capabilities LMF selects an appropriate positioning method. LMF then interacts accordingly to RAN and/or UE to collect required information to determine the UE position using appropriate algorithms. On computing the UE position, the information is returned to the appropriate requesting entity by the CN.

For certain positioning methods, like UL-AoA, Non-UE specific NRPPa messages such as TRP Information Exchange and MEASUREMENT REQUEST may be sent to multiple RANs. The Namf_Communication NonUeN2MessageTransfer service operation is used to transfer these N2 messages to RAN(s) from LMF via AMF.

For Specific positioning methods, LMF can initiate some non-UE associated NRPPa messages, to be sent to multiple RAN nodes. The NRPPa messages for TRP Information Exchange procedure is one such example of non-UE associated NRPPa message, where LMF requests multiple RAN nodes to provide detailed information of TRPs hosted by them. The LMF initiates the procedure by forwarding the non-UE associated NRPPa message to AMF using Namf_Communication NonUeN2Message Transfer service operation. The RAN node identifiers, to which the transfer should be initiated by AMF, are specified in the request body of NonUeN2MessageTransfer along with the NRPPa payload by LMF.

In the execution of this procedure of transferring the non-UE associated NRPPa messages, two fallbacks in the existing services have been identified namely, no indication to LMF about the Partial or Complete failure of non-UE associated NRPPa message transfer by AMF and source RAN node information not known to LMF during the forwarding of non-UE associated NRPPa response by AMF.

In the first fallback situation, there might be situations where AMF is unable to deliver the NRPPa message to some or all of the NG-RAN nodes provided by the LMF. The RAN nodes might not be connected or unreachable to AMF, causing failure in AMF to transfer the message. A partial failure case is when AMF was able to send the NRPPa message to some RAN nodes which are reachable and connected but failed for few others that are either not reachable or not connected to it. The case of complete failure is when the NRPPa message is not transmitted to any of the RAN nodes provided by LMF.

In both partial and complete failure cases, it is crucial for the LMF to know to which RAN nodes the delivery of NRPPa message was unsuccessful. This will assist LMF in the decision of further proceedings of the Positioning process.

Currently, AMF does not have the mechanism to inform LMF about the partial or complete failure in the delivery of NRPPa message, as an indication to LMF in the NonUeN2Transfer response message.

In the second fallback situation, while receiving Non-UE Associated NRPPa response from RAN node(s), AMF forwards the message to LMF using NonUeN2Notify service operation. Here, the AMF only forwards the NRPPa response along with other necessary information to LMF. However, there is no provision for AMF to indicate the source RAN node to LMF in this notification.

There can be possibility that the received NRPPa message might have decoding issue or other error case while LMF tries to decode the received response from RAN node through AMF. In case of any decoding errors or other errors in the received NRPPa packet, LMF triggers NRPPa error indication message which is used to report the detected error in the incoming message to RAN. NRPPa Error Indication for a non-UE associated NRPPa response is transferred as another non-UE associated NRPPa message through NonUeN2MessageTransfer to RAN through AMF. But since the RAN node from which the NRPPa response came from is unknown to LMF, it cannot indicate to which RAN node the AMF needs to forward the error indication. Hence without knowing the target RAN node, LMF cannot assist AMF to forward the NRPPa error message to respective RAN node.

To address the above gaps, the present invention proposes following solutions focusing on a mechanism to report partial or complete failures in NRPPa message transfer to RAN node by AMF. It also proposes the addition of RAN identification in the NRPPA response message to the LMF. Using which LMF can provide the NRPPa Error Indication to RAN node, assisting the AMF to route it to the appropriate RAN node.

The solution for conveying the partial or complete failure on delivery of non-UE associated NRPPa message by AMF to LMF shall be sent as a response message to NonUeN2MessageTransfer Request.

In case of partial failure, AMF shall convey as a successful transfer response to LMF, indicating a “partial success” result in it. Along with that, AMF shall provide the list of RAN nodes for which AMF failed to transfer the NRPPa message with the failure cause for each RAN node.

In case of complete failure, AMF shall convey as an error response to LMF, providing the complete list of RAN nodes and the failure cause for each RAN Node.

In case of partial failure, the success response from AMF is conveyed using the existing “N2InformationTransferRspData” datatype as given in Table 1, below.

TABLE 1
Response from AMF - N2InformationTransferRspData

| Attribute name | Data type | P | Cardinality | Description |
|---|---|---|---|---|
| result | N2InformationTransferResult | M | 1 | This IE shall provide the |
| | | | | result of the N2 information |
| | | | | transfer processing at the |
| | | | | AMF. |
| nrppaRspPerNgranList | array(NrppaRspPerNgran) | C | 1 . . . N | This IE may be present, if |
| | | | | the n2InformationClass is |
| | | | | “NRPPa” in |
| | | | | N2InformationTransferReq |
| | | | | Data, to provide the failure |
| | | | | related to NG-RAN nodes. |
| | | | | This IE shall only be |
| | | | | included if the “result” is |
| | | | | “PARTIAL_N2_INFO_{—} |
| | | | | TRANSFER”. |

From Table 1, the existing “result” attribute in N2InformationTransferRspData conveys the result of N2 Information transfer by AMF. This is a mandatory parameter of data type “N2InformationTransferResult” as mentioned in Table 2. To convey the partial success status to LMF, “PARTIAL_N2_INFO_TRANSFER” has been introduced as another possible enumerated value for the attribute N2InformationTransferResult. The values are as shown in Table 2, below.

TABLE 2
Enumeration N2InformationTransferResult

| Enumeration value | Description |
|---|---|
| “N2_INFO_{—} | This cause code represents the case where |
| TRANSFER_INITIATED” | the AMF has initiated the N2 information |
| | transfer towards the AN. |
| “PARTIAL_N2_{—} | This cause code represents the case where |
| INFO_TRANSFER” | the AMF has initiated the N2 information |
| | transfer towards some of the AN(s) in the |
| | “globalRanNodeList” in |
| | N2InformationTransferReqData. |

As shown in Table 1, the “nrppaRspPerNgranList” attribute is newly added in N2InformationTransferRspData to convey the list of RAN Nodes to which the AMF has failed to initiate NRPPa Message with its failure cause. This attribute will be conditionally added when the “result” value corresponds to “PARTIAL_N2_INFO_TRANSFER”. This attribute is an array of datatype “NrppaRspPerNgran”. The definition of this attribute is provided in Table 3, below.

TABLE 3
Definition of NrppaRspPerNgran

| Attribute | | | Cardi- | |
|---|---|---|---|---|
| name | Data type | P | nality | Description |
| ngranId | GlobalRanNodeId | M | 1 | Indicates the identity of |
| | | | | the failed NG-RAN node |
| | | | | The IE shall contain the |
| | | | | gNB ID. |
| cause | NrppaTransFailure | O | 1 | This IE may be present |
| | | | | to indicate a failure |
| | | | | related to the NG-RAN, |
| | | | | e.g. when the AMF |
| | | | | detects that the NG-RAN |
| | | | | is not reachable. |

In the NrppaRspPerNgran datatype, the attribute ngranId, which is a mandatory parameter, indicates the identity of failed RAN node. The cause attribute is of data type “NrppaTransFailure”, which is an optional parameter, that indicates the failure reason for each failed RAN node as given in Table 3. The values of “cause” attribute is as indicated in Table 4, below.

TABLE 4
Enumeration NrppaTransFailure

| Enumeration value | Description |
|---|---|
| “NG_RAN_{—} | This value indicates that the AMF has failed |
| FAILURE” | to reach the NG-RAN when sending a N2 |
| | information. |
| “NG_RAN_{—} | N2 message cannot be transferred as the |
| NOT_CONNECTED” | requested 5G AN(s) are not connected to |
| | the AMF |

In case of complete failure, error response will be sent by AMF to LMF as “N2InformationTransferError” where an attribute “nrppaErrorInfo” is newly added to indicate full failure to LMF. This attribute is a conditional parameter and is an array of data type “NrppaRspPerNgran” which is explained above in Table 3. The “N2InformationTransferError” is given in Table 5, below.

TABLE 5
Definition of Error Response from AMF - N2InformationTransferError

| Attribute name | Data type | P | Cardinality | Description |
|---|---|---|---|---|
| nrppaErrorInfo | array(NrppaRspPerNgran) | C | 1 . . . N | This IE shall be present if the |
| | | | | n2InformationClass is |
| | | | | “NRPPa” in |
| | | | | N2InformationTransferReqData. |

In case of Source RAN node unknown in LMF during the reception of non-UE associated NRPPa response, the present invention proposes that to convey the RAN Node Identifier to the LMF while forwarding the NRPPa response from AMF. The NRPPa response is transferred using NonUeN2Notify message. The RAN Node information as “ranNodeId”, which is a conditional parameter representing the identifier of RAN node, is newly added in the existing request body of “N2InformationNotification” as given in the Table 6, below.

TABLE 6
Definition of N2 Notify Request body
from AMF - N2InformationNotification

| Attribute | | | Cardi- | |
|---|---|---|---|---|
| name | Data type | P | nality | Description |
| ranNodeId | GlobalRanNodeId | C | 0 . . . 1 | This IE shall be present |
| | | | | during the Location |
| | | | | Service Procedure to |
| | | | | indicate the RAN Node ID |
| | | | | from which the NRPPa |
| | | | | message is received. |
| | | | | When present, it shall |
| | | | | contain the Global RAN |
| | | | | Node ID. The IE shall |
| | | | | contain either the gNB |
| | | | | ID or the NG-eNB ID. |

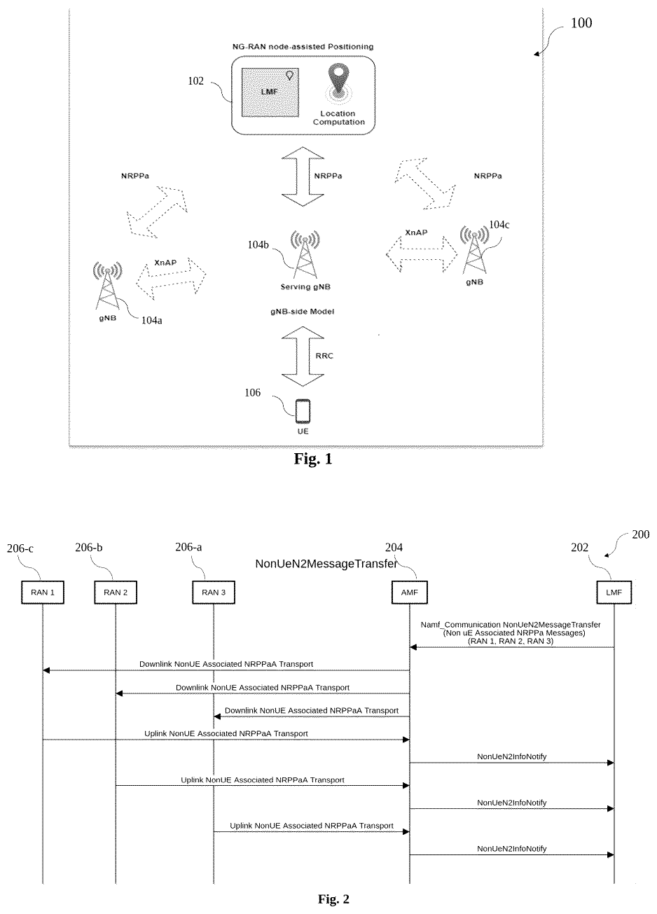

FIG. 1 illustrates a schematic representation of a positioning network architecture according to the embodiments described herein. The architecture 100 includes a Location Management Function (LMF) 102, which acts as a core network entity responsible for location computation.

The architecture 100 further comprises a plurality of base stations, shown as gNBs 104a, 104b, and 104c. A Serving gNB 104b is communicatively coupled to a User Equipment (UE) 106 via a radio interface using Radio Resource Control (RRC) signaling. The Serving gNB 104b is configured to aggregate and pair radio signal measurements received from the UE 106.

The Serving gNB 104b is interconnected with Neighboring gNBs 104a and 104c via an XnAP interface. This interface allows the Serving gNB 104b to request and receive auxiliary radio measurements from neighboring cells. Communication between the LMF 102 and the gNB layer (e.g., Serving gNB 104b) is conducted over a New Radio Positioning Protocol A (NRPPa) protocol.

FIG. 2 illustrates method of NonUeN2Message Transfer in accordance with embodiments of the present disclosure. As illustrated in FIG. 2, these NRPPa messages are transferred by LMF 202 to RAN 206-a, 206-b, 206-c via AMF 204 using the Namf_Communication NonUeN2MessageTransfer service operation. This API of AMF 204 in its request carries information about the RAN Node(s) (206-a, 206-b, 206-c) to which the NRPPa message should be forwarded. Upon this service invocation by LMF 202, the AMF 204 transmits a Downlink Non-UE Associated NRPPa Transport NGAP message separately to each specified RAN Node to transfer the NRPPa payload provided by LMF 202.

To respond to the LMF 202 for the received NRPPa request Message, RAN (206-a, 206-b, 206-c) sends an Uplink Non-UE Associated NRPPa Transport NGAP message to the AMF 204, which AMF 204 then forwards to the LMF 202 using NonUEN2Notify service operation.

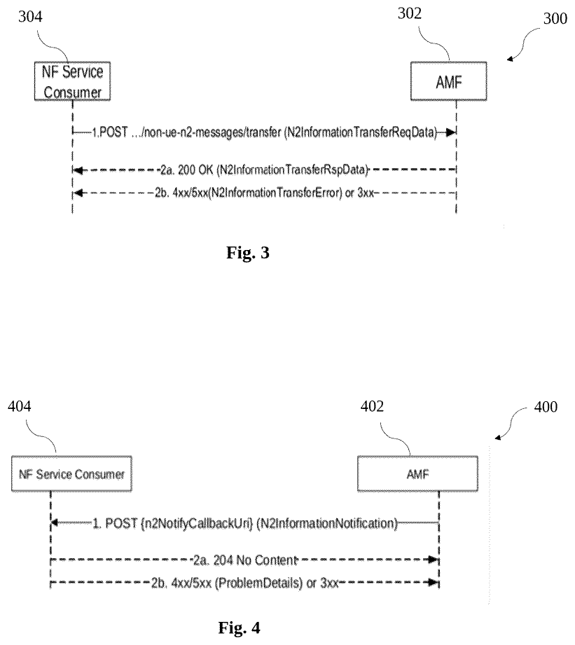

FIG. 3 illustrates another method of NonUeN2Message Transfer in accordance with embodiments of the present disclosure. The communication protocol for handling non-UE associated information transfer is managed through a service-based interaction between an NF Service Consumer 304 and an AMF 302. As illustrated in FIG. 3, the procedure is initiated when the NF Service Consumer 304 invokes a custom operation-specifically a NonUeN2MessageTransfer—by transmitting an HTTP POST request to the AMF 302. This request carries the N2InformationTransferReqData, which encapsulates the N2 information intended for the Access Network (5G-AN) for procedures including, but not limited to, the broadcast of assistance data and the management of network timing synchronization.

The AMF 302, acting as the intermediary relay to the 5G Access Network (5G-AN), processes the request and returns a response based on the delivery outcome. In instances where the AMF 302 successfully processes the transfer for some or all target nodes or the identification of a partial delivery state, it returns a “200 OK” status code. This response includes the N2InformationTransferRspData data structure. In accordance with the technical enhancements for partial error reporting, this structure is configured to carry a list of specific RAN nodes for which the transfer failed, accompanied by a distinct failure cause for each node.

If the AMF 302 determines that the message cannot be delivered to any of the intended targets, or if a protocol error occurs, the AMF 302 returns a failure response (typically a 4xx or 5xx status code). The message body for such failures contains an N2InformationTransferError structure.

The procedure for obtaining non-UE associated network assistance data is realized through the Namf_Communication_NonUeN2MessageTransfer service operation, wherein the NF Service Consumer 304 initiates the transfer of NRPPa class information to one or more NG-RAN nodes via the AMF 302. As illustrated in the FIG. 3, the NF Service Consumer 304 transmits an HTTP POST request containing the N2Information TransferReqData. This request body is specifically configured to carry the NRPPa PDU, a list of target NG-RAN node identifiers, and the NF Instance Identifier (attribute nfId) of the initiating Service Consumer to facilitate subsequent notification routing.

In case of successful or Partial Initiation (200 OK), the AMF 304 returns an HTTP “200 OK” status code containing the N2InformationTransferRspData. If the AMF 304 successfully initiates the transfer to every RAN node specified in the request, the result attribute is set to N2 INFO_TRANSFER INITIATED as listed in Table 2. However, if the transfer fails for a subset of the target nodes, the AMF 304 sets the result attribute to PARTIAL_N2_INFO_TRANSFER as listed in Table 2. In this state, the AMF 304 explicitly provides a list of the specific failed nodes and their respective failure causes within the nrppaRspPerNgranList attribute as indicated in Table 3.

If the AMF 304 cannot initiate the transfer to any of the target nodes, it returns the appropriate error status code. The response body is enhanced to include NRPPa error information per RAN node as defined in Table 5.

FIG. 4 illustrates a method of Non-UE information notify in accordance with embodiments of the present disclosure. As illustrated in FIG. 4, an AMF 402 invokes the NonUeN2InfoNotify service operation to transmit Non-UE N2 information received from the 5G Access Network (5G-AN) to an NF Service Consumer 404. This procedure is critical for several network functions, including obtaining network assistance data, receiving Public Warning System (PWS) events, managing the broadcast of assistance data by a Location Management Function (LMF), and monitoring timing synchronization status.

In this procedure, the AMF 402 initiates this operation by sending an HTTP POST request. The request body carries the N2InformationNotification data structure, with the N2 information that includes from RAN identifier of received RAN to the NF Service Consumer 404. Upon successful receipt and processing of the notification, the NF Service Consumer 404 returns a “204 No Content” status code with an empty response body.

In the event of a delivery failure or redirection, the NF Service Consumer 404 returns an appropriate HTTP status code.

FIG. 5 illustrates a block diagram depicting the components of a core network communication system 500 in accordance with an embodiment of the present disclosure. As shown in FIG. 5, the Network Function (NF) 1 502 (e.g., an Access and Mobility Management Function (AMF)) may comprise a processor 514, memory 512 storing instructions, and communication circuitry comprising a transmitter 516 and receiver 518 configured to perform the methods herein. As shown in FIG. 5, the NF 2 504 (e.g., a Location Management Function (LMF) or Session Management Function (SMF) or User Plane Function (UPF)) may comprise a processor 524, memory 522 storing instructions, and communication circuitry comprising a transmitter 526 and receiver 528 configured to perform the methods herein. The NF 1 502 and NF 2 504 may communicate via a service-based interface.

FIG. 5 in accordance with an embodiment of the present disclosure illustrates only one memory and processor. It is apparent to a skilled person in the art that a NF 1 and NF 2 may include one or more processors and one or more memories. The memory may also be referred to as a storage medium, a storage device, or the like. The memory may be disposed independent of the processor, or may be integrated with the processor. This is not to be accorded as a limitation of the embodiment described in this disclosure.

In an embodiment of this disclosure, a radio frequency circuit that have a receiving and sending function may be considered as a transceiver unit of the terminal. The transceiver unit may also be referred to as a transceiver (including a transmitter and/or a receiver), a transceiver machine, a transceiver apparatus, or the like. The processing unit may also be referred to as a processor, a processing module, a processing apparatus, or the like. Optionally, a component configured to implement a receiving function in the transceiver unit may be considered as a receiving unit, and a component configured to implement a sending function in the transceiver unit may be considered as a transmitting unit. In other words, the transceiver unit includes the receiving unit and the transmitting unit. This is not to be accorded as a limitation of the embodiment described in this disclosure.

In some embodiments, the transceiver unit and the processing unit may be integrated together or may be disposed independently. In addition, all functions of the processing unit may be integrated into one chip for implementation. Alternatively, some functions may be integrated into one chip for implementation and some other functions are integrated into one or more other chips for implementation.

It should be understood that division of the modules of the foregoing apparatus is merely division of logical functions, and in actual implementation, all or some modules may be integrated into one physical entity, or may be physically separated. In addition, all of these modules may be implemented in a form of invoking software by a processor element, or all of these modules may be implemented in a form of hardware, or some modules are implemented in a form of invoking software by a processor element, and some modules are implemented in a form of hardware. For example, the receiving module may be a separately disposed processor element, or may be integrated into a chip of the foregoing apparatus for implementation. In addition, the receiving module may alternatively be stored in a memory of the foregoing apparatus in a form of program code, and a processor element of the foregoing apparatus invokes and executes a function of the foregoing receiving module. Implementation of other modules is similar to that of the receiving module. In addition, all or some of these modules may be integrated together, or may be implemented separately. The processor element described herein may be an integrated circuit and has a signal processing capability. In an implementation process, steps in the foregoing methods or the foregoing modules can be implemented by using a hardware integrated logical circuit in the processor element, or by using instructions in a form of software.

All or some of the foregoing embodiments may be implemented by using software, hardware, firmware, or any combination thereof. When software is used to implement the embodiments, all or some of the embodiments may be implemented in a form of a computer program product. The computer program product includes one or more computer instructions. When the computer program instructions are loaded and executed on a computer, the procedures or functions according to embodiments of this application are all or partially generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a DVD), a semiconductor medium (for example, a solid-state drive (SSD)), or the like.

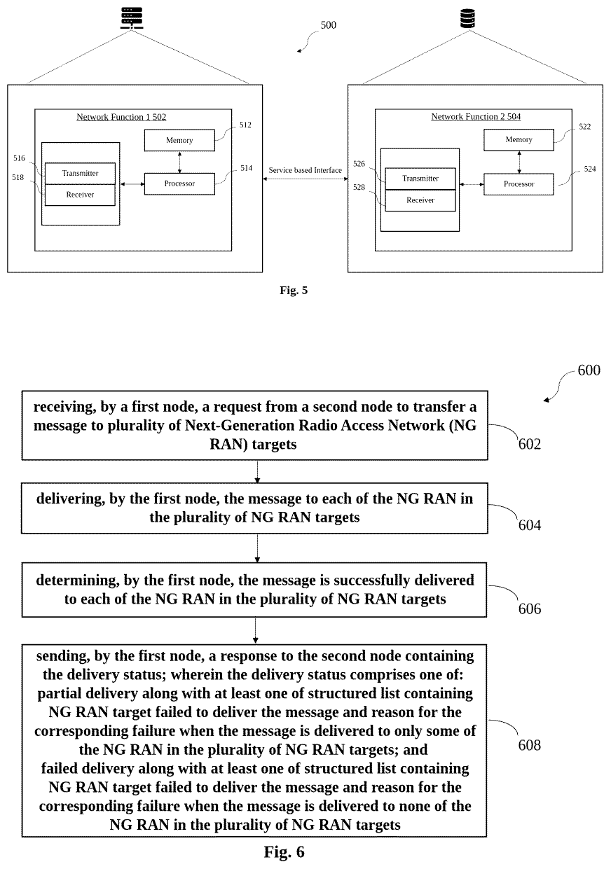

FIG. 6 illustrates a method for handling communication in a network for a user equipment (UE) positioning in a wireless communication system in accordance with an embodiment of the present disclosure. The operations of method 600 presented below are intended to be illustrative. In some implementations, method 600 may be accomplished with one or more additional operations not described, and/or without one or more of the operations discussed. Additionally, the order in which the operations of method 600 are illustrated in FIG. 6 and described below is not intended to be limiting.

According to an embodiment, the method 600 may be implemented by one or more processors or modules illustrated and explained through FIGS. 1 and 5, therefore detailed explanation of the same is omitted here for the sake of brevity.

Step 602 may include receiving, by a first node, a request from a second node to transfer a message to plurality of Next-Generation Radio Access Network (NG RAN) targets.

Step 604 may include delivering, by the first node, the message to each of the NG RAN in the plurality of NG RAN targets.

Step 606 may include determining, by the first node, the message is successfully delivered to each of the NG RAN in the plurality of NG RAN targets.

Step 608 may include sending, by the first node, a response to the second node containing the delivery status; wherein the delivery status comprises one of: partial delivery along with at least one of structured list containing NG RAN target failed to deliver the message and reason for the corresponding failure when the message is delivered to only some of the NG RAN in the plurality of NG RAN targets, and failed delivery along with at least one of structured list containing NG RAN target failed to deliver the message and reason for the corresponding failure when the message is delivered to none of the NG RAN in the plurality of NG RAN targets.

In an embodiment, the first node is an Access and Mobility Management Function (AMF), and the second node is a Location Management Function (LMF).

In an embodiment, the request is using Namf_Communication NonUeN2Message Transfer service of the AMF.

In an embodiment, the message is transferred using New Radio Positioning Protocol A (NRPPa).

In an embodiment, the message contains non-UE associated N2 information.

In an embodiment, the response is provided using N2InformationTransferRspData datatype in Namf_Communication NonUeN2MessageTransfer service in case of partial delivery.

In an embodiment, the N2InformationTransferRspData comprises of: the attribute “result” of enumeration data type “N2InfomartionTranferResult” to define the partial delivery state with the value set to “PARTIAL_N2_INFO_TRANSFER”, and the attribute “nrppaRspPerNgranList” is of a list structure, wherein the list comprises the node identifier of the failed node and optionally a cause value that indicates a failure related to that NG RAN.

In an embodiment, the response is provided using N2InformationTransferError datatype in Namf_Communication NonUeN2MessageTransfer service in case of failed delivery.

In an embodiment, the N2InformationTransferError comprises the attribute “nrppaErrorInfo” is of a list structure, wherein the list comprises the node identifier of the failed node and optionally a cause value.

In an embodiment, the nrppaErrorInfo can be optionally present.

In an embodiment, the list structure is of datatype “nrppaRspNgran”.

In an embodiment, the node identifier is represented by an attribute “ngranId” of data type “GlobalRanNodeId” that indicates the identity of the NG-RAN.

In an embodiment, the cause value is represented by attribute “cause” of datatype “NrrpaTransFailure”.

In an embodiment, the NrrpaTransFailure may comprise of one of following failure cause: the first node has failed to reach the NG-RAN when sending a N2 information represented by enumeration value “NGRAN_RAN_NODE_NOT_REACHABLE”, or N2 message cannot be transferred as the requested NG-RAN is unknown to the first node represented by enumeration value “NG_RAN_NODE_UNKNOWN”.

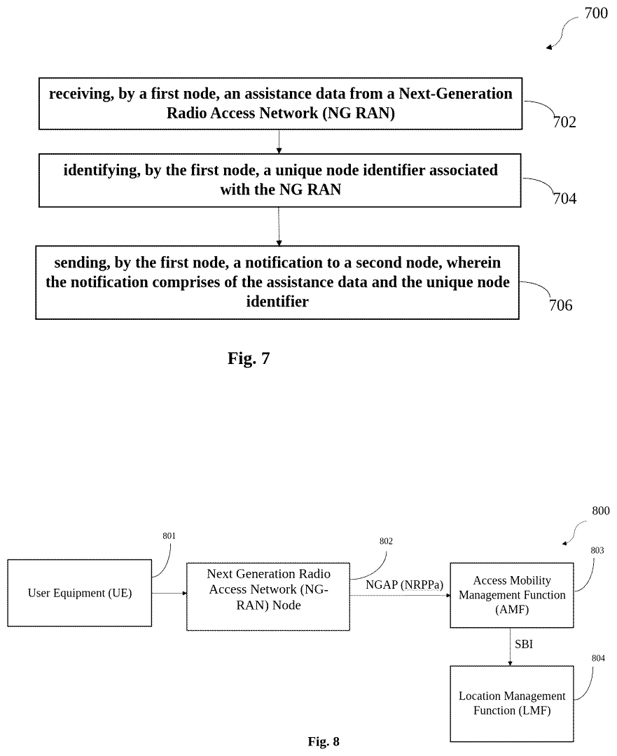

FIG. 7 illustrates a method for providing source information in a network for a user equipment (UE) positioning in a wireless communication system in accordance with an embodiment of the present disclosure. The operations of method 700 presented below are intended to be illustrative. In some implementations, method 700 may be accomplished with one or more additional operations not described, and/or without one or more of the operations discussed. Additionally, the order in which the operations of method 700 are illustrated in FIG. 8 and described below is not intended to be limiting.

According to an embodiment, the method 700 may be implemented by one or more processors or modules illustrated and explained through FIGS. 1 and 5, therefore detailed explanation of the same is omitted here for the sake of brevity.

Step 702 may include receiving, by a first node, an assistance data from a Next-Generation Radio Access Network (NG RAN).

Step 704 may include identifying, by the first node, a unique node identifier associated with the NG RAN.

Step 706 may include sending, by the first node, a notification to a second node, wherein the notification comprises of the assistance data and the unique node identifier.

In an embodiment, the first node is an Access and Mobility Management Function (AMF) and the second node is a Location Management Function (LMF).

In an embodiment, the notification is using Namf_Communication NonUeN2InfoNotify service of the AMF.

In an embodiment, the assistance data is received using New Radio Positioning Protocol A (NRPPa).

In an embodiment, the assistance data contains non-UE associated N2 information.

In an embodiment, the unique node identifier represented as attribute “ranNodeId” indicating the RAN identifier from which the NRPPa message is received.

FIG. 8 illustrates an example communication system 800 configured to implement positioning methods described in the present disclosure. FIG. 8 particularly illustrates a communication system architecture configured to implement positioning methods as shown in FIGS. 2 to 4 of this disclosure. The system comprises a target UE 801, a Next-Generation Radio Access Network (NG-RAN) node 802, an Access and Mobility Management Function (AMF) 803, and a Location Management Function (LMF) 804. These entities interact through defined protocol, not limiting to, Next Generation Application Protocol (NGAP), and New Radio Positioning Protocol A (NRPPa), to provide a hardware and software framework for model training and interaction.

The NG-RAN node 802 (e.g., a gNB) serves as the primary apparatus for executing the positioning logic. As shown in FIG. 8, the NG-RAN node 802 configured to predict UE 801 location coordinates or signal characteristics based on radio inputs.

In an embodiment, the AMF 803 is configured to receive a request from the LMF 807 to transfer a message to the target NG RAN node 802. Further, AMF 803 is configured to deliver the message to target NG RAN node 802 and also to determine whether the message is successfully delivered to the target NG RAN node 802. The AMF 803 is further configured to send a response to the LMF 804 containing the partial delivery state and a structured list containing target NG RAN node 802 to which the AMF 803 failed to send the message.

In another embodiment, the AMF 803 is configured to receive an assistance data from the NG RAN node 802. Further, AMF 803 is configured to identify a unique node identifier associated with the NG RAN node 802 from which the assistance data was received. The AMF 903 is further configured to send a notification to the LMF 804, the notification comprising both the assistance data and the unique node identifier.

The figures of the disclosure are provided to illustrate some examples of the invention described. The figures are not to limit the scope of the depicted embodiments of the appended claims. Aspects of the disclosure are described herein with reference to the invention to example embodiments for illustration. It should be understood that specific details, relationships, and method are set forth to provide a full understanding of the example embodiments. One of ordinary skill in the art recognize the example embodiments can be practiced without one or more specific details and/or with other methods.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

It is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

We claim:

1. A method of communication in a wireless network for a user equipment (UE) positioning, the method comprising:
receiving, by a first node, a request from a second node to transfer a message to plurality of Next-Generation Radio Access Network (NG RAN) targets;
delivering, by the first node, the message to each of the NG RAN in the plurality of NG RAN targets;
determining, by the first node, the message is successfully delivered to each of the NG RAN in the plurality of NG RAN targets; and
sending, by the first node, a response to the second node containing the delivery status; wherein the delivery status comprises one of:
partial delivery along with at least one of structured list containing NG RAN target failed to deliver the message and reason for the corresponding failure when the message is delivered to only some of the NG RAN in the plurality of NG RAN targets; and
failed delivery along with at least one of structured list containing NG RAN target failed to deliver the message and reason for the corresponding failure when the message is delivered to none of the NG RAN in the plurality of NG RAN targets.

2. The method as claimed in claim 1, wherein:
the first node is an Access and Mobility Management Function (AMF); and
the second node is a Location Management Function (LMF).

3. The method as claimed in claim 1, wherein the request is using Namf_Communication NonUeN2MessageTransfer service of the AMF.

4. The method as claimed in claim 1, wherein the message is transferred using New Radio Positioning Protocol A (NRPPa).

5. The method as claimed in claim 1, wherein the message contains non-UE associated N2 information.

6. The method as claimed in claim 1, wherein the response is provided using N2InformationTransferRspData datatype in Namf_Communication NonUeN2MessageTransfer service in case of partial delivery.

7. The method as claimed in claim 6, wherein, the N2InformationTransferRspData comprises of:
the attribute “result” of enumeration data type “N2InfomartionTranferResult” to define the partial delivery state with the value set to “PARTIAL_N2_INFO_TRANSFER”; and
the attribute “nrppaRspPerNgranList” is of a list structure, wherein the list comprises the node identifier of the failed node and optionally a cause value that indicates a failure related to that NG RAN.

8. The method as claimed in claim 1, wherein the response is provided using N2InformationTransferError datatype in Namf_Communication NonUeN2MessageTransfer service in case of failed delivery.

9. The method as claimed in claim 8, wherein the N2InformationTransferError comprises of:
the attribute “nrppaErrorInfo” is of a list structure, wherein the list comprises the node identifier of the failed node and optionally the cause value.

10. The method as claimed in claim 9, wherein the nrppaErrorInfo can be optionally present.

11. The method as claimed in claim 4 or claim 9, wherein the list structure is of datatype “nrppaRspNgran”.

12. The method as claimed in claim 4 or claim 9, wherein the node identifier is represented by an attribute “ngranId” of data type “GlobalRanNodeld” that indicates the identity of the NG-RAN.

13. The method as claimed in claim 4 or claim 9, wherein the cause value is represented by attribute “cause” of datatype “NrrpaTransFailure”.

14. The method as claimed in claim 13, wherein the NrrpaTransFailure may comprise of one of following failure cause:
the first node has failed to reach the NG-RAN when sending a N2 information represented by enumeration value “NGRAN_RAN_NODE_NOT_REACHABLE”; or
N2 message cannot be transferred as the requested NG-RAN is unknown to the first node represented by enumeration value “NG_RAN_NODE_UNKNOWN”.

15. A method for providing source information in a network for user equipment (UE) positioning, the method comprising:
receiving, by a first node, an assistance data from a Next-Generation Radio Access Network (NG RAN);
identifying, by the first node, a unique node identifier associated with the NG RAN; and
sending, by the first node, a notification to a second node, wherein the notification comprises of the assistance data and the unique node identifier.

16. The method as claimed in claim 15, wherein:
the first node is an Access and Mobility Management Function (AMF); and
the second node is a Location Management Function (LMF).

17. The method as claimed in claim 15, wherein the notification is using Namf_Communication NonUeN2InfoNotify service of the AMF.

18. The method as claimed in claim 15, wherein the assistance data is received using New Radio Positioning Protocol A (NRPPa).

19. The method as claimed in claim 15, wherein the assistance data contains non-UE associated N2 information.

20. The method as claimed in claim 15 or claim 18, wherein the unique node identifier represented as attribute “ranNodeId” indicating the RAN identifier from which the NRPPa message is received.
